(19) United States
(12) Patent Application Publication
(10) Pub. No.: US 2023/0299604 A1
(43) Pub. Date: Sep. 21, 2023

(54) CONTROL DEVICE, METHOD OF CONTROLLING DISCHARGE OF ENERGY STORAGE DEVICE, AND COMPUTER PROGRAM

(71) Applicant: GS Yuasa International Ltd., Kyoto (JP)

(72) Inventors: Hiromasa MURAMATSU, Kyoto (JP); Heisuke NISHIKAWA, Kyoto (JP)

(73) Assignee: GS Yuasa International Ltd., Kyoto (JP)

(21) Appl. No.: 18/018,574

(22) PCT Filed: Jul. 21, 2021
(86) PCT No.: PCT/JP2021/027270

§ 371 Date: Jan. 29, 2023

(30) Foreign Application Priority Data
Jul. 30, 2020 (JP) 2020-129608
Jul. 9, 2021 (JP) 2021-114386

(51) Int. Cl. H02J 7/00; H01M 10/44

(52) U.S. Cl. CPC H02J 7/007182; H01M 10/44; H02J 7/0048

(57) ABSTRACT

A control device 4 includes a control unit 41 that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

### TECHNICAL FIELD

The present invention relates to a control device that controls discharge of an energy storage device, a method of controlling discharge of an energy storage device, and a computer program.

### BACKGROUND ART

In order to realize high capacity of an energy storage device, high capacity of a negative electrode is required. In a lithium ion secondary battery of Patent Document 1, it is disclosed that Li metal is contained as a negative active material. By using Li metal for a negative electrode, a capacity of discharge of the negative electrode is significantly improved from 372 mAh/g in a case of using graphite to 3860 mAh/g. When Li metal is used for a negative electrode, potential of the negative electrode is always 0 V vs. Li/Li+, and the potential is lower than that in a case where graphite is used, so that battery voltage can be increased. Further, accordingly, a positive electrode can also exhibit lower potential capacity, and energy density of a battery is dramatically improved.

### PRIOR ART DOCUMENT

### Patent Document

Patent Document 1: JP-A-2001-243957

### SUMMARY OF THE INVENTION

### Problems to be Solved by the Invention

In a case of a lithium ion secondary battery using Li metal for a negative electrode as disclosed in Patent Document 1 and the like, a dendrite of Li metal is generated on the negative electrode in a deposition process of Li metal associated with charge, and there is a problem that a discharge capacity retention ratio is lowered.

An object of the present invention is to provide a control device that suppresses decrease in a discharge capacity retention ratio of an energy storage device, a method of controlling discharge of an energy storage device, and a computer program.

### Means for Solving the Problems

A control device according to an aspect of the present invention includes a control unit that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

A control device according to an aspect of the present invention includes a control unit that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

A method of controlling discharge of an energy storage device according to an aspect of the present invention terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

A computer program according to an aspect of the present invention causes a computer to execute processing of terminating discharge of an energy storage device including a negative electrode that contains Li during charge and releases Li during discharge in a case where a capacity limit amount based on a capacity of discharge and an amount of charge is reached , or in a case where voltage reaches termination voltage larger than lower limit voltage of a voltage range in which charge and discharge can be reversibly repeated.

### Advantages Of The Invention

According to the above aspect, decrease in a discharge capacity retention ratio is suppressed.

### BRIEF DESCRIPTION OF THE DRAWINGS

FIG. 1 is a block diagram illustrating a configuration of a charge-discharge system and a server according to a first embodiment.

FIG. 2 is a perspective view of a battery module.

FIG. 3 is a flowchart showing a procedure of charge-discharge control by a control unit.

FIG. 4 is a perspective view of an appearance of HAPS.

FIG. 5 is a block diagram illustrating a configuration of HAPS.

FIG. 6 is a graph showing a relationship between the number of cycles and a capacity of discharge between Example 1, Example 2, and Comparative Example 1.

FIG. 7 is a graph showing a relationship between the number of cycles and a discharge capacity retention ratio between Example 1, Example 2, and Comparative Example 1.

### MODE FOR CARRYING OUT THE INVENTION

### (Outline of Embodiment)

Hereinafter, a case of an energy storage device including a liquid (solution) electrolyte as an electrolyte will be described.

As charge and discharge are repeated, a relationship between battery capacity and battery voltage changes. With deterioration, a coating film called a solid electrolyte interphase (SEI) coating film, which is formed by a decomposition product of a component of electrolyte solution, is formed on a surface of a negative electrode, the SEI coating film is deposited around Li, and an amount of Li captured by the SEI coating film and not substantially involved in battery reaction increases. Further, since the deposit is insulating, resistance of the battery increases as an amount of the deposit increases, and polarization during charge and discharge becomes large. For this reason, a depth of discharge (DOD) at the same battery voltage decreases, a relationship between a capacity of discharge and voltage changes, and a discharge capacity retention ratio decreases. Further, even in a case where Li metal is depleted of due to isolation and inactivation of the Li metal accompanying repeated charge and discharge, the above relationship changes, and a discharge capacity retention ratio decreases.

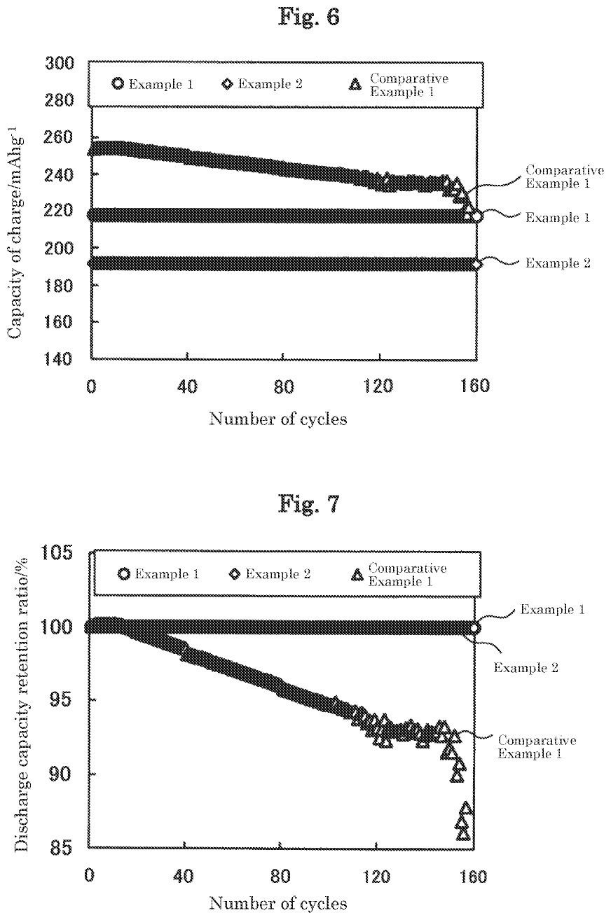

The present inventors have found that in a case where an energy storage device including a negative electrode in which Li metal is deposited and dissolved during charge and discharge is fully charged and then repeatedly discharged until lower limit voltage of complete discharge of 100% DOD is reached, a discharge capacity retention ratio decreases with time according to a change in the above relationship (see Comparative Example 1 in FIGS. 6 and 7 described later). Furthermore, it was also found that a discharge capacity retention ratio rapidly decreases in a case where a predetermined number of cycles is exceeded. The rapid decrease in a discharge capacity retention ratio is considered to be due to the fact that a dendrite of Li generated in a negative electrode grows in a positive electrode direction and penetrates a separator, which causes internal short-circuit.

There are various mechanisms for producing a Li dendrite, and an example of the mechanisms is as described below. During charge, Li ions of electrolyte solution enter from a portion having a crystal defect of an SEI coating having small resistance, and are deposited on a surface of a negative electrode. Therefore, Li metal is unevenly deposited on the negative electrode. In a case where Li metal is unevenly deposited on the negative electrode, stress is locally applied to the SEI coating, and this stress breaks a fragile portion of the SEI coating, and a dendrite is generated from the broken portion.

The present inventors have found that in a case where charge and discharge are repeated by terminating discharge before DOD becomes 100%, a rapid decrease in a discharge capacity retention ratio in a case where a predetermined number of cycles is exceeded is suppressed, and have arrived at the present invention.

That is, a control device according to the embodiment includes a control unit that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

The control device according to the embodiment may include a control unit that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

Here, examples of the negative electrode include a metal negative electrode containing metal such as Li metal or Na.

The amount of charge may be battery capacity or may be acquired for each charge. Among them, it is preferable to acquire the amount of charge at an initial stage of a charge-discharge cycle.

In a case where complete discharge is performed, that is, discharge is performed until DOD reaches 100%, an amount of Li metal dissolved and deposited (amount of inflow and outflow) during charge and discharge is maximized. An SEI coating becomes unstable due to increase in an amount of Li metal dissolved and deposited, that is, a surface of the coating becomes uneven, and a dendrite is likely to be generated locally. By terminating the discharge before DOD reaches 100% and reducing an amount of Li metal dissolved and deposited, the SEI coating is stabilized, and the coating surface becomes smooth, that is, the degree of dendrite growth is suppressed. Therefore, a rapid decrease in a discharge capacity retention ratio in a case where a predetermined number of cycles is exceeded is suppressed.

It is possible to increase integrated charge-discharge capacity until a discharge capacity retention ratio rapidly decreases due to generation of dendrite, and it is possible to prolong a use period of an energy storage device. The timing at which a discharge capacity retention ratio rapidly decreases, that is, the timing at which an internal short-circuit occurs greatly varies depending on the number of charge-discharge cycles, a capacity limit amount, and capacity per area of a positive electrode and a negative electrode. The timing can be delayed by controlling the capacity limit amount and the capacity per area of a positive electrode and a negative electrode.

In a case where complete discharge is not performed, an amount of Li metal dissolved on a surface of a negative electrode is reduced, Li that is captured by an SEI coating and cannot be involved in battery reaction can be compensated, decrease in DOD at the same voltage can be suppressed, a change in a relationship between a capacity of discharge and voltage can be suppressed, and decrease in a discharge capacity retention ratio can be suppressed.

In a case where termination voltage is cV, when lower limit voltage is 2.00 V, c is more than 2.00 V, and the lower limit of c is more preferably 2.5 V or 3.0 V in this order. The upper limit of c is more preferably 3.3 V or 3.2 V in this order.

In the control device, the capacity limit amount may be DOD smaller than 100% or a state of charge (SOC) larger than 0%. The DOD or the SOC is obtained by, for example, a current integration method or the like that calculates the DOD or the SOC based on discharge capacity derived from the product of actually measured current and time.

In a case where DOD as the capacity limit amount is a%, a is less than 100%, and the upper limit of a is more preferably 98%, 95%, or 90% in this order. The lower limit of a is more preferably 70%, 75%, or 80% in this order.

When SOC as the capacity limit amount is b%, b exceeds 0%, and the lower limit of b is more preferably 2%, 5%, or 10% in this order. The upper limit of b is more preferably 30%, 25%, or 20% in this order.

The capacity limit amount is determined in consideration of a required amount of electricity during one time of discharge.

As described above, a relationship between a capacity of discharge and voltage changes. When termination of discharge is determined by voltage, DOD at termination voltage gradually decreases, and a discharge capacity retention ratio decreases. In a case where capacity of discharge (discharge capacity) is actually measured, DOD or SOC is derived based on the capacity of discharge and an amount of charge at the time of full charge, and discharge is terminated, DOD is kept constant. Therefore, termination of discharge is preferably determined by DOD or SOC.

The capacity limit amount is represented by discharge capacity, and may be obtained by multiplying an amount of charge by b/100.

In a case where charge is performed after discharge is finished, SOC is charged to 100%. Further, charge may be performed until SOC reaches a range of 80% to 90%.

In the control device described above, the negative electrode may have an active material containing Li metal.

Conventionally, in a negative electrode containing Li metal, in a case where a process in which charge is performed after discharge is performed until lower limit voltage of complete discharge is reached is repeated, in a case where a predetermined number of cycles is exceeded, a discharge capacity retention ratio is remarkably decreased. However, with the above configuration, decrease in a discharge capacity retention ratio is excellently suppressed.

In the control device, the energy storage device may include a positive electrode containing a transition metal oxide.

According to the above configuration, in the energy storage device including a positive electrode containing a transition metal oxide, a change in a relationship between a capacity of discharge and voltage is suppressed, and decrease in a discharge capacity retention ratio is suppressed.

A method of controlling discharge of an energy storage device according to the embodiment terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

According to the above configuration, it is possible to suppress decrease in DOD with time at the same voltage, and it is possible to suppress rapid decrease in a discharge capacity retention ratio in a case where a predetermined number of cycles is exceeded.

A computer program according to the embodiment causes a computer to execute processing of terminating discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

According to the above configuration, it is possible to suppress decrease in DOD with time at the same voltage, and it is possible to suppress rapid decrease in a discharge capacity retention ratio in a case where a predetermined number of cycles is exceeded.

### FIRST EMBODIMENT

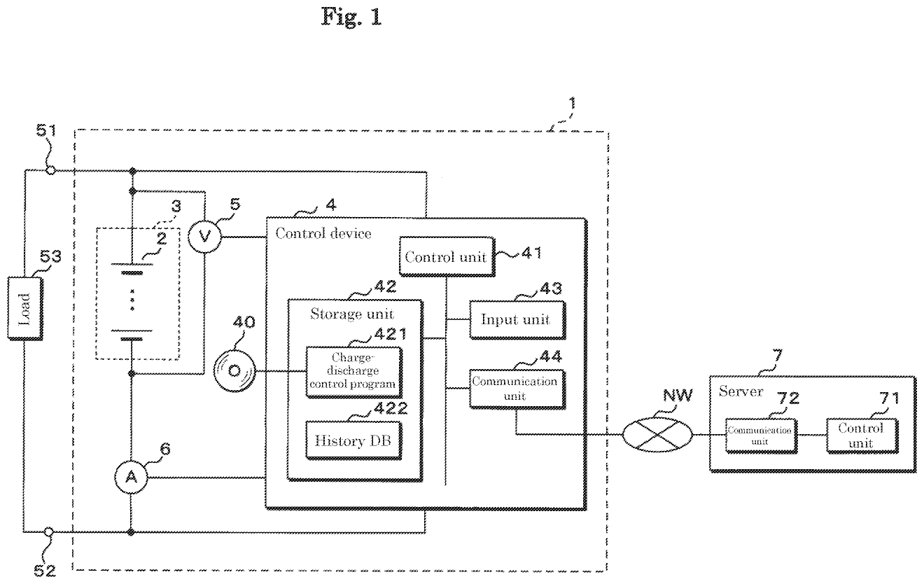

FIG. 1 is a block diagram illustrating a configuration of a charge-discharge system 1 and a server 7 according to a first embodiment. The charge-discharge system 1 is provided in, for example, transportation equipment including an automobile and a railway, industrial equipment including that for aviation, space, and construction, and the like, and is exemplified by a system having a large depth during one time of discharge of a battery module 3.

The charge-discharge system 1 includes the battery module 3, a control device 4, a voltage sensor 5, and a current sensor 6.

In the battery module 3, lithium ion secondary batteries (hereinafter, referred to as battery cells) 2 as a plurality of energy storage devices are connected in series. The control device 4 controls the entire charge-discharge system 1.

The server 7 includes a control unit 71 and a communication unit 72. The control device 4 includes a control unit 41, a storage unit 42, an input unit 43, and a communication unit 44.

The control unit 41 of the control device 4 is connected to the control unit 71 via the communication unit 44, a network NW, and the communication unit 72.

A load 53 is connected to the battery module 3 via terminals 51 and 52. In a case of charging, a charger is connected to the battery module 3.

The control units 41 and 71 include, for example, a central processing unit (CPU), a read only memory (ROM), a random access memory (RAM), and the like, and control operation of the control device 4 and the server 7, respectively.

The storage unit 42 stores various programs and data. The storage unit 42 stores a charge-discharge control program (hereinafter, referred to as control program) 421. The control program 421 is provided in a state of being stored in a computer-readable recording medium 40 such as a CD-ROM, a DVD-ROM, or a USB memory, for example, and is stored in the storage unit 42 by being installed in the control device 4. Further, the control program 421 may be acquired from an external computer (not illustrated) connected to a communication network and stored in the storage unit 42.

The storage unit 42 also stores a charge-discharge history DB 422. The charge-discharge history is an operation history of battery module 3, and is information including information indicating a period (use period) during which the battery module 3 performs charge or discharge, information on charge or discharge performed by the battery module 3 during the use period, and the like. The information indicating a use period of the battery module 3 is information including information indicating start and end time points of charge or discharge, an accumulated use period in which the battery module 3 is used, and the like. The information on charge or discharge performed by the battery module 3 is information indicating voltage, a rate, and the like at the time of charge or discharge performed by the battery module 3.

The communication units 44 and 72 have a function of communicating with other devices via the network NW, and can transmit and receive necessary information.

In the present embodiment, either the control device 4 or the server 7 functions as the control device of the present invention. Note that in a case where the server 7 does not function as the control device, the charge-discharge system 1 does not need to be connected to the server 7.

Although FIG. 1 illustrates a case where one set of the battery modules 3 are provided, a plurality of sets of the battery modules 3 may be connected in series.

The control device 4 may be a battery electronic control unit (ECU).

The voltage sensor 5 is connected in parallel to the battery module 3, and outputs a detection result corresponding to the entire voltage of the battery module 3. The voltage sensor 5 is connected to a positive electrode terminal 23 and a negative electrode terminal 26, which will be described later, of each of the battery cells 2, measures voltage Vi between the positive electrode terminal 23 and the negative electrode terminal 26 of each of the battery cells 2, and detects voltage V between a negative electrode lead 33 and a positive electrode lead 34, which will be described later, of the battery module 3, which is a total value of Vi of the battery cells 2.

The current sensor 6 is connected in series to the battery module 3, and outputs a detection result according to current of the battery module 3.

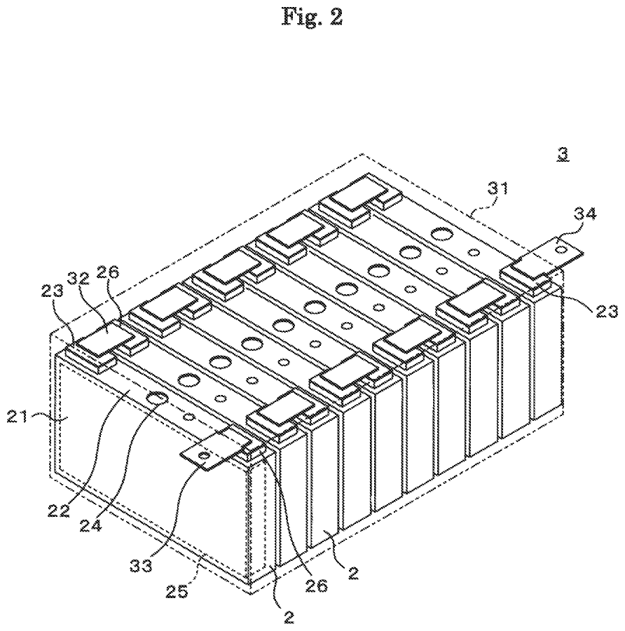

FIG. 2 is a perspective view of the battery module 3. The battery module 3 includes a case 31 having a rectangular parallelepiped shape and a plurality of the battery cells 2 housed in the case 31.

The battery cell 2 includes a case 21 having a rectangular parallelepiped (prismatic) shape, a lid plate 22, the positive electrode terminal 23 and the negative electrode terminal 26 provided on the lid plate 22, a rupture valve 24, and an electrode assembly 25. Instead of a prismatic cell, the battery cell may be what is called a pouch cell including a laminate case. The electrode assembly 25 is formed by stacking a positive electrode plate, a separator, and a negative electrode plate, and is housed in the case 21.

The electrode assembly 25 may be obtained by winding a positive electrode plate and a negative electrode plate in a flat shape with a separator interposed between them, or may be obtained by stacking a plurality of positive electrode plates and a plurality of negative electrode plates with a separator interposed between them.

The positive electrode plate is obtained by forming an active material layer on positive electrode substrate foil which is plate-like (sheet-like) or long strip-like metal foil made from metal such as aluminum, titanium, tantalum, or stainless steel or an alloy of the metal. The negative electrode plate is obtained by forming an active material layer on negative electrode substrate foil which is plate-like (sheet-like) or long strip-like metal foil made from metal such as copper, nickel, stainless steel, or nickel-plated steel or an alloy of the metal. The separator is a microporous sheet made from synthetic resin.

A positive active material can be appropriately selected from publicly-known positive active materials, for example. As a positive active material for a lithium ion secondary battery, a material capable of occluding and releasing Li ions is usually used. Examples of the positive active material include a lithium transition metal composite oxide having an α-NaFeO₂-type crystal structure and a lithium transition metal oxide having a spinel-type crystal structure. Examples of the lithium transition metal composite oxide having an α-NaFeO₂-type crystal structure include Li[LiₓNi₁₋ₓ]O₂ (0≤x<0.5), Li[LiₓNi_{γ}Co_{(1-x-y)}]O₂ (0≤x<0.5, 0<γ<1), Li[LiₓCo₍₁₋ₓ)]O₂ (0≤x<0.5), Li[LiₓNi_{γ}Mn_{(1-x-γ)}]O₂ (0≤x<0.5, 0<γ<1), Li[LiₓNi_{γ}Mn_{β}Co_{(1-x-γ-β)}]O₂ (0≤x≤0.5, 0<γ, 0<β, 0.5<γ+β≤1), and Li[LiₓNi_{γ}Co_{β}Al_{(1-x-γ-β)}]O₂ (0≤x<0.5, 0<γ, 0<β, 0.5<γ+β<1). Examples of the lithium transition metal oxide having a spinel-type crystal structure include LiₓMn₂O₄ and LiₓNi_{γ}Mn_{(2-γ)}o₄. These materials may have surfaces coated with other materials. In a positive active material layer, one type of these materials may be used alone, or two or more types of the materials may be used in mixture. In the positive active material layer, one type of these compounds may be used alone, or two or more types of the compounds may be used in mixture. Content of the positive active material in the positive active material layer is not particularly limited, but the lower limit of the content is preferably 50 mass %, more preferably 80 mass %, and still more preferably 90 mass %. The upper limit of the content is preferably 99 mass %, and more preferably 98 mass %.

A positive composite forming the active material layer of the positive electrode contains optional components such as a conductive agent, a binder, a thickener, and a filler as necessary. Examples of the conductive agent include carbonaceous materials such as carbon black, metal, and conductive ceramics. Examples of the binder include thermoplastic resin such as fluororesin (polytetrafluoroethylene (PTFE), polyvinylidene fluoride (PVDF), and the like), polyethylene, polypropylene, and polyimide. Examples of the thickener include polysaccharide polymers such as carboxymethyl cellulose (CMC) and methyl cellulose. Examples of the filler include polyolefins such as polypropylene and polyethylene.

A negative active material used for a negative active material layer preferably contains Li metal. Since the negative active material contains Li metal, excessive Li ions are contained, and Li ions are transferred from a negative electrode to a positive electrode, so that required a capacity of discharge can be exhibited. The Li metal includes a Li alloy in addition to a Li simple substance. Examples of the Li alloy include a LiAl alloy. The negative electrode containing Li metal can be manufactured by cutting Li metal into a predetermined shape or molding Li metal into a predetermined shape. In this case, a negative electrode substrate made from stainless steel may be connected only to an end portion of a Li metal plate.

Furthermore, the negative active material layer may contain elements such as Na, K, Ca, Fe, Mg, Si, and N.

The lower limit of the content of Li metal in the negative active material is preferably 80 mass %, more preferably 90 mass %, and still more preferably 95 mass %. The upper limit of the content may be 100 mass %.

Electrolyte solution is injected into the case 21. The electrolyte solution contains a nonaqueous solvent, and a sulfur-based cyclic compound, fluorinated cyclic carbonate, chain carbonate, and electrolyte salt dissolved in a nonaqueous solvent. Examples of the sulfur-based cyclic compound include compounds having a sultone structure or a cyclic sulfate structure. Examples of the fluorinated cyclic carbonate include fluoroethylene carbonate. Examples of the chain carbonate include ethyl methyl carbonate and dimethyl carbonate.

The negative active material of the battery cell 2 may contain Li metal, and the positive active material may be a lithium-rich type. According to the battery cell 2, a high capacity of discharge can be exhibited.

As the positive active material, NCM (Ni+Co+Mn-based mixed positive active material) represented by Liₓ(NiₐCo_{b}Mnₑ)O₂ (a+b+c=1, 0<x<1.1) or the like may be used. In order to realize high energy density of the battery cell 2, content of Mn may be increased. Further, Ni and Co do not need to be contained.

The positive electrode terminal 23 and the negative electrode terminal 26 of the battery cells 2 adjacent to each other of the battery module 3 are electrically connected by a bus bar 32, so that a plurality of the battery cells 2 are connected in series.

The positive electrode lead 34 and the negative electrode lead 33 for extracting electric power are provided on the positive electrode terminal 23 and the negative electrode terminal 26 of the battery cells 2 at both ends of the battery module 3.

A specific example of the battery cell 2 will be described.

### [Positive Electrode]

As the positive active material, a lithium transition metal composite oxide represented by Liₓ(NiₐCo_{b}Mnₑ)O₂ is used. Here, a molar ratio Li/Me of Li to Me (Ni, Co, Mn) is 1.33.

Positive electrode paste containing N-methylpyrrolidone (NMP) as a dispersion medium and the positive active material, acetylene black (AB) as a conductive agent, and polyvinylidene fluoride (PVdF) as a binder at a mass ratio of 92.5:4.5:3.0 is prepared. The positive electrode paste is applied to one surface of aluminum foil having a thickness of 15 μm as a positive electrode substrate, dried, pressed, and then cut to prepare a positive electrode in which a positive active material layer is arranged in a rectangular shape having a width of 30 mm and a length of 40 mm. A thickness of the positive active material layer is about 150 μm, and a positive composite is contained in an amount of 26 mg/cm² per unit area. The positive electrode is used after being dried under reduced pressure at 120° C. for 14 hours or more.

### [Production of Negative Electrode]

A Li metal plate having a width of 30 mm, a length of 42 mm, and a thickness of 100 μm is used as a negative electrode plate. The Li metal plates are pressed at a pressure of 1.4 MPa with a metal-resin composite film interposed between them. A negative electrode substrate made from stainless steel is connected to the Li metal plate only at an end portion having a length of 5 mm.

### [Preparation of Electrolyte Solution]

Solution is prepared by dissolving LiPF₆ at a concentration of 1 mol dm⁻³ in a mixed solvent obtained by mixing fluoroethylene carbonate (FEC) and dimethyl carbonate (DMC) at a volume ratio of FEC:DMC=30:70.

Furthermore, 2 mass % of 1,3-propenesultone is added to the solution to obtain electrolyte solution.

### [Production of Battery Cell 2]

A polypropylene microporous membrane having a thickness of 27 μm that is surface-modified with polyacrylate is used as a separator. Four of the separators are placed on each other, and the periphery of the separators excluding one side is fused to produce a bag-shaped separator having three bag portions. A negative electrode is inserted into a bag portion at the center of the bag-shaped separator, and two positive electrodes are inserted into bag portions on both sides of the bag portion at the center so that surfaces on which positive active material layers are arranged face the negative electrode. As described above, the electrode assembly 25 of a stacked type having two facing surfaces of the positive electrode and the negative electrode is produced.

The electrode assembly 25 is housed in a metal-resin composite film which is the case 21 in a manner that open end portions of lead terminals connected to the positive electrode and the negative electrode in advance are exposed to the outside, and the metal-resin composite film is sealed except for a portion which becomes an electrolyte solution filling hole, and then the electrolyte solution filling hole is hermetically sealed after filling with electrolyte solution is performed. The battery cell 2 is produced as described above.

The configuration of the battery cell 2 is not limited to the above case. Lithium may be attached to a negative electrode.

The battery cell 2 may be a positive electrode limiting type. In a case where Li metal is used for a negative electrode, potential of the negative electrode does not change during charge and discharge, and a capacity of discharge of the battery cell 2 is limited by a capacity of discharge of a positive electrode. Accordingly, this is the positive electrode limiting type.

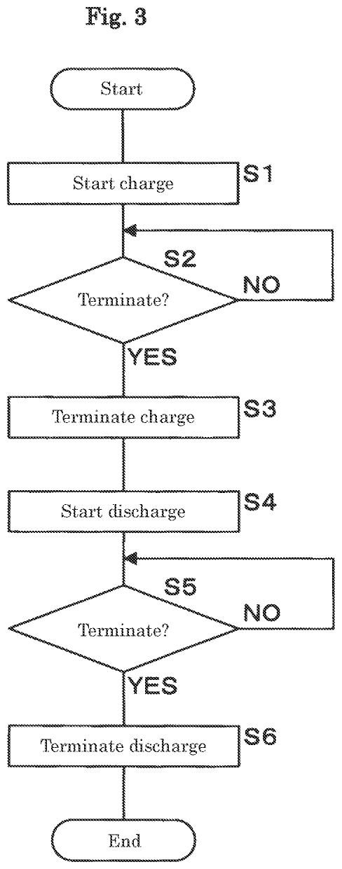

FIG. 3 is a flowchart showing a procedure for controlling charge and discharge of the battery module 3 by the control unit 41.

The control unit 41 starts charge of the battery module 3 (S1). The control unit 41 determines whether or not to terminate charge (S2). In a case where an amount of charge reaches a predetermined value, the control unit 41 determines to terminate the charge. In a case where SOC reaches 100%, the control unit 41 may determine to terminate the charge. In a case of determining not to terminate the charge (S2: NO), the control unit 41 repeats the determination processing.

In a case of determining to terminate the charge (S2: YES), the control unit 41 terminates the charge (S3).

The control unit 41 starts discharge (S4). The control unit 41 determines whether or not to terminate the discharge (S5). The control unit 41 determines whether or not a capacity of discharge reaches a capacity limit amount based on an initial amount of charge. At the start of discharge, the control unit 41 starts measurement of discharge capacity, and determines whether the discharge capacity reaches a capacity limit amount obtained by multiplying the initial amount of charge by b/100 described above. The control unit 41 may determine whether or not DOD reaches a% described above or whether or not SOC reaches b% described above. The control unit 41 may determine whether or not voltage reaches cV described above. In a case of determining not to terminate the discharge (S5: NO), the control unit 41 repeats the determination processing.

In a case of determining to terminate the discharge (S5: YES), the control unit 41 terminates the discharge (S6) and terminates the charge-discharge control processing. The control unit 41 repeats the processing from S1 to S6.

In the present embodiment, since discharge is terminated before DOD becomes 100%, an amount of Li metal dissolved and deposited on a surface of a negative electrode is reduced, an amount of SEI newly deposited on the negative electrode is reduced, Li that is captured by an SEI coating and cannot be involved in battery reaction can be compensated, and decrease in DOD with time at the same voltage is suppressed. Therefore, decrease in a discharge capacity retention ratio is suppressed. Further, depletion of Li metal is delayed by reduction in an amount of Li metal dissolved and deposited in the negative electrode. Therefore, rapid decrease in a discharge capacity retention ratio in a case where the number of cycles increases is suppressed. It is possible to increase integrated charge-discharge capacity until a discharge capacity retention ratio rapidly decreases due to growth of a dendrite.

Although the battery cell 2 is the positive electrode limiting type, due to consumption (depletion) of Li, the battery cell 2 may be switched to a negative electrode limiting type, the capacity balance between positive and negative electrodes may be shifted, and capacity deterioration may occur. However, according to the charge-discharge control of the present embodiment, the positive electrode limiting type is maintained, and capacity deterioration is suppressed.

### SECOND EMBODIMENT

A second embodiment will be described by taking HAPS 10 as an example of a flying object. The flying object may be, but is not limited to, an electric vertical takeoff and landing aircraft (eVTOL). The flying object includes a power generation device and an energy storage device, and preferably does not include an internal combustion engine.

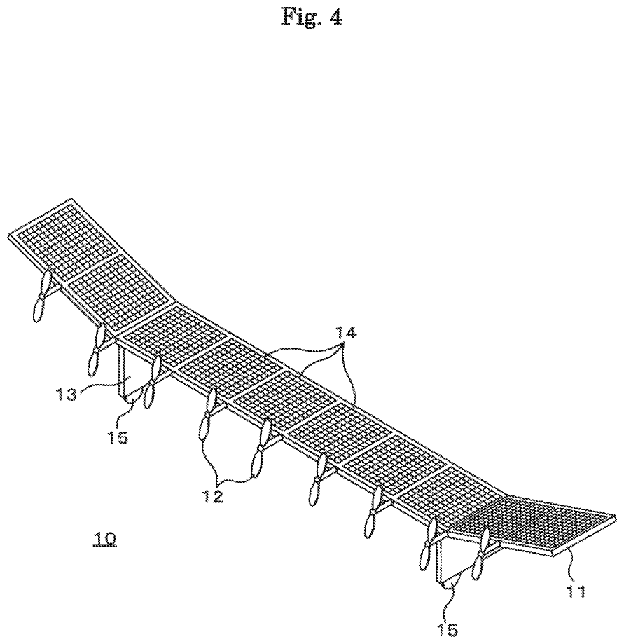

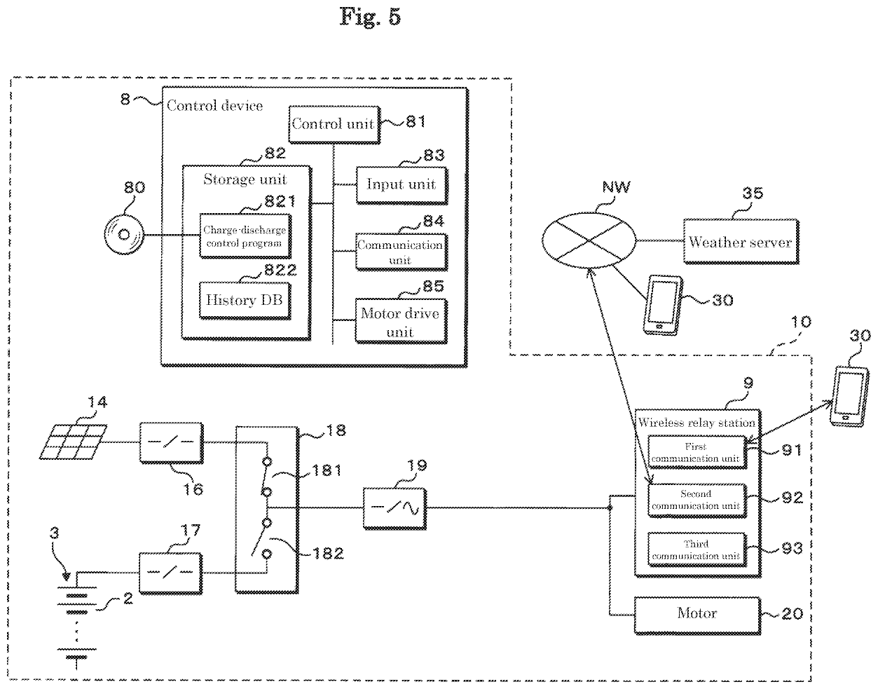

FIG. 4 is a perspective view of an appearance of the HAPS 10, and FIG. 5 is a block diagram illustrating a configuration of the HAPS 10. In FIG. 5, connection between a control device 8 and each unit is omitted.

The HAPS 10 includes a wing portion 11, a plurality of propellers 12, a plurality of leg portions 13, a plurality of solar panels 14, the battery module 3, the control device 8, a wireless relay station 9, a wheel 15, a first converter circuit 16, a second converter circuit 17, a switching unit 18, and an inverter circuit 19. The propeller 12 is connected to a motor 20. The configuration of the HAPS 10 is not limited to this example. The battery module 3, the control device 8, the wireless relay station 9, the first converter circuit 16, the second converter circuit 17, the switching unit 18, and the inverter circuit 19 are housed in the leg portion 13. Alternatively, they may be provided in the wing portion 11.

The HAPS 10 equipped with the wireless relay station 9 enables simultaneous connection with a large number of terminal devices in a wide range, and cooperation between the HAPS 10 and an artificial satellite and a ground station enables construction of a high-speed communication infrastructure. A stable communication environment can be maintained even at the time of disaster.

The solar panel 14 is formed by arranging and connecting a plurality of modules in which a plurality of silicon-based solar batteries is arranged, for example.

The battery module 3 is formed by, for example, connecting a plurality of the battery cells 2 in series and/or in parallel. A plurality of the battery modules 3 may be connected in series to form a bank, and the banks may be connected in parallel. The battery cell 2 and the battery module 3 have similar configurations as those of the battery cell 2 and the battery module 3 according to the first embodiment.

The control device 8 includes a control unit 81, a storage unit 82, an input unit 83, a communication unit 84, and a motor drive unit 85.

The control unit 81 includes, for example, a CPU, a ROM, a RAM, and the like, and controls operation of each unit of the HAPS 10. The control unit 81 executes processing of charge-discharge control by reading and executing a charge-discharge control program (hereinafter, referred to as control program) 821 to be described later. The control program 821 has a configuration similar to that of the control program 421.

The storage unit 82 stores various programs including the control program 821 and a history DB 822. The control program 821 is provided in a state of being stored in a computer-readable recording medium 80, and is stored in the storage unit 82 by being installed in the control device 8. Alternatively, the control program 821 may be acquired from an external computer and stored in the storage unit 82.

The history DB 822 may store history data of power generation and discharge of the solar panel 14, history data of charge and discharge of the battery module 3, history data of weather information, history data of flight control of the HAPS 10, and the like. The history of power generation and discharge of the solar panel 14 is an operation history of the solar panel 14, and may include a history of information indicating a use period, information regarding power generation (electric power or the like), or information regarding discharge (voltage, rate, and the like). The history of charge and discharge of the battery module 3 is an operation history of the battery module 3, and may include a history of information indicating a use period and information on charge or discharge (voltage, rate, and the like).

The history of weather information may be a history of a wind speed and a wind direction, a sunlight amount, and the like at a position of the HAPS 10 at the time of acquisition acquired from a weather server 35.

The history of flight control may be a history of control of the flight of the HAPS 10 including rotational drive such as the number of revolutions and rotation time of the motor 20.

The input unit 83 receives a detection result of current and voltage of the solar panel 14 and the battery module 3. In FIG. 5, an ammeter and a voltmeter are omitted.

The communication unit 84 has a function of communicating with other devices such as the wireless relay station 9, and transmits and receives necessary information.

The motor drive unit 85 controls rotational drive of the motors 20 of the propellers 12.

The first converter circuit 16 is a DC/DC converter, is connected to the solar panel 14, and boosts and outputs output voltage of the solar panel 14.

The second converter circuit 17 is connected to the battery module 3, and is a bidirectional DC/DC converter that discharges and charges the battery module 3.

The inverter circuit 19 converts DC into AC. That is, DC power input from the switching unit 18 is converted into AC power and output.

The switching unit 18 includes, for example, two switches 181 and 182 connected in series. In FIG. 5, a control circuit for controlling charge and discharge is omitted. The switch 181 and the switch 182 include switching elements such as a relay and a power MOSFET. A connection point between the switch 181 and the switch 182 is connected to the inverter circuit 19. The other end of the switch 181 and the other end of the switch 182 are connected to the first converter circuit 16 and the second converter circuit 17, respectively.

A load such as the wireless relay station 9 and the motor 20 is connected to the inverter circuit 19.

In a case of discharge from the solar panel 14 to a load, the switch 181 is turned on to connect the solar panel 14 to the load. FIG. 5 illustrates a state in which the switch 181 is turned on and power is supplied from the solar panel 14 to a load.

In a case where the battery module 3 is discharged to a load, the switch 182 is turned on to connect the battery module 3 to the load.

In a case of discharge from the solar panel 14 and the battery module 3 to a load, both the switch 181 and the switch 182 are turned on to connect the solar panel 14 and the battery module 3 to the load.

The wireless relay station 9 includes a first communication unit 91, a second communication unit 92, and a third communication unit 93.

The first communication unit 91 includes an antenna, a transmitting and receiving device, an amplifier, and the like, and transmits and receives a radio signal to and from a terminal device 30 used by the user in an airplane, a communication terminal device 30 of a drone, or the like. The second communication unit 92 includes an antenna, a transmitting and receiving device, an amplifier, and the like, and transmits and receives a radio signal to and from a relay station on the ground or on the sea. The wireless relay station 9 is connected to the network NW of a mobile communication network via the relay station. The terminal device 30 is connected to the network NW. In FIG. 5, a relay station on the ground or on the sea is omitted. The third communication unit 93 performs transmission and reception with an artificial satellite and another HAPS by laser light or the like. The configuration of the wireless relay station 9 is not limited to this example.

The motor 20 rotationally drives the propeller 12. Alternatively, the motor 20 may drive a flying object propulsion device or a flying object ascending device other than those in the mode illustrated in FIG. 4.

The HAPS 10 configured as described above moves obliquely upward away from the ground, then floats with lift while turning in a predetermined area in the horizontal direction, and ascends to an airspace A. Examples of the airspace A include airspaces in the stratosphere at altitudes of 11 km to 50 km. Among them, an airspace at an altitude of 20 km is preferable. After ascending to the airspace A, the HAPS 10 horizontally moves to a position B in the horizontal direction and stays at the position B.

Since power cannot be generated by the solar panel 14 at night, the battery module 3 supplies power. The battery module 3 supplies power in a case of flying by driving of the motor 20, and supplies power to the control unit 81, the input unit 83, the communication unit 84, the wireless relay station 9, and the like, which is required even in a case where the HAPS 10 glides in the airspace A.

Since power is supplied by the battery module 3 until power is generated by the solar panel 14, a depth of discharge at night increases.

In the present embodiment, similarly to the first embodiment, discharge is terminated in a case where discharge capacity of the battery module 3 reaches b% of an amount of charge, in a case where DOD reaches a% which is smaller than 100%, in a case where SOC reaches b% which is larger than 0%, or in a case where cV which is larger than lower limit voltage of complete discharge is reached. Since complete discharge is not performed, a change in a relationship between a capacity of discharge and voltage can be suppressed, and decrease in a discharge capacity retention ratio can be suppressed. A rapid decrease in a discharge capacity retention ratio in a case where the number of cycles increases is also suppressed.

It is possible to increase integrated charge-discharge capacity until a discharge capacity retention ratio rapidly decreases due to generation of a dendrite. The HAPS 10 is required to establish a high-speed communication infrastructure by simultaneously connecting with a large number of terminal devices in a wide range over a predetermined period such as half a year. According to the present embodiment, it is possible to stably perform discharge at night over a longer period of time, to stably perform flight operation, and to maintain a stable communication environment.

### EXAMPLES

Hereinafter, an example of the present invention will be specifically described, but the present invention is not limited to this example.

### Example 1

The battery cell 2 was produced based on the production method described above. A positive electrode of the battery cell 2 was the Li-excess NCM positive electrode described above, and a Li metal plate having a thickness of 100 μm was used as a negative electrode. Battery capacity is 130 mAh.

Charge was performed at a rate of 0.2 CA from 2.0 V to 4.6 V, that is, charge was performed at SOC of 0% to 100%. Next, discharge was performed at a rate of 0.1 CA until DOD was 0% to 90% (until the SOC was 100% to 10%). Charge at SOC of 10% to 100% and discharge at SOC of 100% to 10% were repeated.

### Example 2

After charge was performed at a rate of 0.2 CA at SOC of 0% to 100%, discharge was performed until DOD reached 0% to 80% (until SOC reached 100% to 20%), and charge at SOC of 20% to 100% and discharge at SOC of 100% to 20% were repeated.

### Example 3

Charge was performed at a rate of 0.2 CA until SOC reached 0% to 100%, and then discharge was performed at a rate of 0.1 CA until discharge voltage reached 3.12 V, and charge until charge voltage reached 4.60 V and discharge until discharge voltage reached 3.12 V were repeated.

### Example 4

Charge was performed at a rate of 0.2 CA until SOC reached 0% to 100%, and then discharge was performed at a rate of 0.1 CA until discharge voltage reached 3.27 V, and charge until charge voltage reached 4.60 V and discharge until discharge voltage reached 3.27 V were repeated.

### Comparative Example 1

Charge was performed at a rate of 0.2 CA until SOC reached 0% to 100%, and then discharge was performed at a rate of 0.1 CA until discharge voltage reached 2.00 V, and charge until charge voltage reached 4.60 V and discharge until discharge voltage reached 2.00 V were repeated.

### Comparative Example 2

Charge was performed at a rate of 0.2 CA until SOC reached 0% to 100%, and then discharge was performed at a rate of 0.1 CA until discharge voltage reached 2.00 V, and charge until charge voltage reached 4.48 V and discharge until discharge voltage reached 2.00 V were repeated.

### Comparative Example 3

Charge was performed at a rate of 0.2 CA until SOC reached 0% to 100%, and then discharge was performed at a rate of 0.1 CA until discharge voltage reached 3.27 V, and charge until charge voltage reached 4.34 V and discharge until discharge voltage reached 3.27 V were repeated.

### Comparative Example 4

Charge was performed at a rate of 0.2 CA until SOC reached 0% to 100%, and then discharge was performed at a rate of 0.1 CA until discharge voltage reached 2.00 V, and charge until charge voltage reached 4.34 V and discharge until discharge voltage reached 2.00 V were repeated.

Table 1 below shows content of charge-discharge control in Examples 1 to 4 and Comparative Examples 1 to 4. Table 1 also shows a discharge capacity retention ratio after 160 cycles of charge and discharge for Examples 1 to 4 and Comparative Examples 1 to 4.

TABLE 1

| | | | Discharge |
|---|---|---|---|
| | | | capacity |
| | | Cut voltage | retention |
| | SOC(%) | (V vs. Li/Li⁺) | ratio (%) |
| Example 1 | At time of discharge | — | 100 |
| | 10 | | |
| | At time of charge 100 | | |
| Example 2 | At time of discharge | — | 100 |
| | 20 | | |
| | At time of charge 100 | | |
| Example 3 | — | Discharge voltage 3.12 | 92 |
| | | Charge voltage 4.60 | |
| Example 4 | — | Discharge voltage 3.27 | 86 |
| | | Charge voltage 4.60 | |
| Comparative | — | Discharge voltage 2.00 | 54 |
| Example 1 | | Charge voltage 4.60 | |
| Comparative | — | Discharge voltage 2.00 | 70 |
| Example 2 | | Charge voltage 4.48 | |
| Comparative | — | Discharge voltage 3.27 | 75 |
| Example 3 | | Charge voltage 4.34 | |
| Comparative | — | Discharge voltage 2.00 | 64 |
| Example 4 | | Charge voltage 4.34 | |

FIG. 6 is a graph showing a relationship between the number of cycles and a capacity of discharge between Example 1, Example 2, and Comparative Example 1. In FIG. 6, the horizontal axis represents the number of cycles, and the vertical axis represents a capacity of discharge (mAhg⁻¹). FIG. 7 is a graph showing a relationship between the number of cycles and a discharge capacity retention ratio between Example 1, Example 2, and Comparative Example 1. In FIG. 7, the horizontal axis represents the number of cycles, and the vertical axis represents a discharge capacity retention ratio (%).

Table 1, FIG. 6, and FIG. 7 show that in the case of Comparative Example 1 in which full charge and complete discharge are repeated, a capacity of discharge decreases with time, and after a 150th cycle, a capacity of discharge rapidly decreases, and a discharge capacity retention ratio significantly decreases.

From Table 1, FIG. 6, and FIG. 7, in the case of Example 1 in which discharge is terminated at SOC of 10% and Example 2 in which discharge is terminated at SOC of 20%, a capacity of discharge does not change even when 160 cycles of charge and discharge are performed, and a discharge capacity retention ratio is 100%.

In Table 1, a discharge capacity retention ratio of Example 1 is higher than a discharge capacity retention ratio of Example 3. Cut voltage of Example 3 is 3.12 (V vs. Li/Li+), which corresponds to DOD of 90% (SOC 10%) of the battery cell 2 in an initial stage. In a case where termination of discharge is determined by voltage, a relationship between a capacity of discharge and voltage changes with time. Therefore, even when discharge is terminated at the identical cut voltage of 3.12 V, SOC gradually becomes 10% or more (DOD becomes less than 90%), and a capacity of discharge decreases. In the case of Example 1, since termination of discharge is determined by SOC based on electric capacity actually measured at the time of charge and discharge, a capacity of discharge of 100% can be held.

Similarly, a discharge capacity retention ratio of Example 2 is higher than a discharge capacity retention ratio of Example 4. Cut voltage of Example 4 is 3.27 (V vs. Li/Li+), which corresponds to DOD of 80% (SOC 20%) of the battery cell 2 in an initial stage. In a case where termination of discharge is determined by voltage, even if discharge is terminated at the identical cut voltage of 3.27 V, SOC gradually becomes 20% or more, and a capacity of discharge decreases. In the case of Example 2, since termination of discharge is determined by SOC based on electric capacity actually measured at the time of charge and discharge, a capacity of discharge of 100% can be held. From the above, it was confirmed that decrease in a discharge capacity retention ratio can be more favorably suppressed by determining termination of discharge by capacity than by voltage.

Comparison between Example 3 and Example 4 shows that the upper limit of voltage c is preferably 3.3 V and more preferably 3.2 V.

From Table 1, FIG. 6, and FIG. 7, the lower limit of a threshold b of SOC when discharge is terminated is more preferably 2%, 5%, and 10% in this order. The upper limit of b is more preferably 30%, 25%, or 20% in this order.

Further, in a case where a Li-excess positive electrode is used as a positive electrode, charge voltage is increased in order to exhibit capacity. The number of charge-discharge cycles required to exhibit this capacity varies depending on charge voltage. For this reason, a permutation of charge voltage and a permutation of a discharge capacity retention ratio may be reversed.

In the above description, an example of an energy storage device including a negative electrode including a liquid electrolyte (electrolyte solution) as an electrolyte is described. The control device, the method of controlling discharge of an energy storage device, and the computer program of the present disclosure can also be applied to an energy storage device including a solid electrolyte. Examples of the solid electrolyte include a solid electrolyte including an inorganic material such as sulfide-based or oxide-based material, and a solid electrolyte having a polymer material such as polyethylene oxide (PEO)-based material. The solid electrolyte may be, for example, a gel electrolyte formed of polymer gel.

Even in a case of an energy storage device which includes a solid electrolyte, contains Li during charge, and includes a negative electrode which releases Li during discharge, generation of a dendrite, and isolation and inactivation of Li metal accompanying repeated charge and discharge occur. That is, a dendrite is generated through a grain boundary in the solid electrolyte as charge and discharge are repeated. Since Li metal not substantially involved in battery reaction is generated, and Li metal substantially involved in battery reaction is depleted of, a relationship between a capacity of discharge and voltage changes, and a discharge capacity retention ratio decreases. By applying the present control device, method of controlling discharge of an energy storage device, and computer program to an energy storage device including a solid electrolyte, decrease in a discharge capacity retention ratio can be suppressed.

The above embodiment is not restrictive. A scope of the present invention is intended to include all modifications within the meaning and scope equivalent to the claims.

The energy storage device is not limited to a lithium ion secondary battery. The energy storage device may be another secondary battery or a capacitor.

### DESCRIPTION OF REFERENCE SIGNS

1: charge-discharge system
2: battery cell
3: battery module
4, 8: control device
40, 80: recording medium
41, 81: control unit
42, 82: storage unit
421, 821: charge-discharge control program
422, 822: history
DB43, 83: input unit
44, 84: communication unit
85: motor drive unit
7: server
9: wireless relay station
10: HAPS
11: wing portion
12: propeller
13: leg portion
14: solar panel
15: wheel
20: motor

1. A control device comprising a control unit that terminates discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.

2. A control device comprising a control unit that terminates discharge of an energy storage device including a negative electrode that contains Li during charge and releases Li to electrolyte solution during discharge in a case where a capacity limit amount based on a capacity of discharge and an amount of charge is reached, or in a case where voltage reaches termination voltage larger than lower limit voltage of a voltage range in which charge and discharge can be reversibly repeated.

3. The control device according to claim 1, wherein the capacity limit amount is a depth of discharge smaller than 100% or SOC larger than 0%.

4. The control device according to claim 1, wherein the negative electrode includes an active material containing Li metal.

5. The control device according to claim 1, wherein the energy storage device includes a positive electrode containing a transition metal oxide.

6. A method of controlling discharge of an energy storage device including a negative electrode that contains Li during charge and releases Li during discharge comprising terminating discharge in a case where a capacity limit amount based on a capacity of discharge and an amount of charge is reached, or in a case where voltage reaches termination voltage larger than lower limit voltage of a voltage range in which charge and discharge can be reversibly repeated.

7. A computer program that causes a computer to execute processing of terminating discharge of an energy storage device including a negative electrode that contains Li during charge and releases Li during discharge in a case where a capacity limit amount based on a capacity of discharge and an amount of charge is reached, or in a case where voltage reaches termination voltage larger than lower limit voltage of a voltage range in which charge and discharge can be reversibly repeated.
